(19) United States
(12) Patent Application Publication
(10) Pub. No.: US 2015/0020180 A1
(43) Pub. Date: Jan. 15, 2015

(54) WIRELESS TWO-FACTOR AUTHENTICATION, AUTHORIZATION AND AUDIT SYSTEM WITH CLOSE PROXIMITY BETWEEN MASS STORAGE DEVICE AND COMMUNICATION DEVICE

(71) Applicant: Peer Intelligence Technology Limited, Hong Kong (HK)

(72) Inventors: Sai Fong Ngan, Hong Kong (HK); Wai Ching Vincent Lok, Hong Kong (HK); Kwok Hung Cheung, Hong Kong (HK)

(73) Assignee: PEER INTELLIGENCE TECHNOLOGY LIMITED, Hong Kong (HK)

(21) Appl. No.: 14/284,464

(22) Filed: May 22, 2014

Related U.S. Application Data
(60) Provisional application No. 61/846,085, filed on Jul. 15, 2013.

(51) Int. Cl. H04L 29/06

(52) U.S. Cl. CPC H04L 63/083; H04L 63/107
USPC 726/7

(57) ABSTRACT

A wireless two-factor authentication, authorization and audit system includes: a mass storage device being connected with a computer; a cloud-based authentication, authorization and audit server being connected with the Internet; and an authenticator device configured to establish wireless communication with the mass storage device, and to communicate with the authentication, authorization and audit server via the Internet. The mass storage device includes a processor connected with the computer, an RF frontend connected with the processor, and a memory storage connected with the processor. The processor is configured to encrypt data before the data is stored in the memory storage, to decrypt the data upon successful authentication, and to grant a user access to the data based on a passphrase, geographical location information, or proximity presence of the authenticator device.

### CROSS REFERENCES TO RELATED APPLICATION

This application claims the benefit of U.S. Provisional Patent Application No. 61/846,085 filed on Jul. 15, 2013; the contents of which is hereby incorporated by reference.

### FIELD OF THE PATENT APPLICATION

The present patent application generally relates to computer security systems and methods and more specifically to a system and a method of wireless two-factor authentication, authorization and audit mechanism for securely accessing a portable mass storage device with close proximity of a communication device.

### BACKGROUND

Portable mass storage devices, such as USB/E-SATA/thunderbolt hard disks/flash drives are commonly used on various computer systems (PC, Macs) today. Typically these portable mass storage devices require no specific authentication so that its content can be accessed on any host computer.

### SUMMARY

The present patent application is directed to a wireless two-factor authentication, authorization and audit system. In one aspect, the system includes: a mass storage device being connected with a computer; a cloud-based authentication, authorization and audit server being connected with the Internet; and an authenticator device configured to establish wireless communication with the mass storage device, and to communicate with the authentication, authorization and audit server via the Internet. The mass storage device includes a processor connected with the computer, an RF frontend connected with the processor, and a memory storage connected with the processor. The processor is configured to encrypt data before the data is stored in the memory storage, to decrypt the data upon successful authentication, and to grant a user access to the data based on a passphrase, geographical location information, or proximity presence of the authenticator device.

The authenticator device may be configured to establish a wireless connection with the mass storage device upon successful wireless connection physical layer authentication between the authenticator device and the mass storage device. The authenticator device may be configured to authenticate a passphrase input by a user. The portable mass storage device and the authenticator device may be configured to perform an upper layer challenge-response authentication. The authenticator device may include a GPS, the GPS being configured to obtain the geographical location of the authenticator device, and report the geographical location to the authentication, authorization and audit server for authentication.

The processor may stop granting access to the user when the authenticator device is out of the proximity of the mass storage device. The wireless two-factor authentication, authorization and audit system may further include a proxy device being in wireless communication with the mass storage device. The proxy device may be configured to send an authentication request to the authentication, authorization and audit server, and the authenticator device may be configured to receive a notification from the authentication, authorization and audit server, and to communicate with the mass storage device through a secure communication channel via the proxy device.

The wireless two-factor authentication, authorization and audit system may further include a proxy device being in wireless communication with the mass storage device. The proxy device may be configured to start a server-mode authentication request to the authentication, authorization and audit server, and upon successful authentication the authentication, authorization and audit server may be configured to send an authenticated message back to the proxy device.

The wireless two-factor authentication, authorization and audit system may further include a plurality of authenticator devices. Upon a request from the proxy device, the authentication, authorization and audit server may be configured to send a notification to all the authenticator devices, and all the authenticator devices may be configured to communicate with the processor of the mass storage device via the proxy device. The proxy device may be one of the authenticator devices.

After sending an authentication request to the authentication, authorization and audit server, the proxy device may be configured to receive a list of conditions to be fulfilled so as to authenticate the mass storage device, one of the conditions being related to at least one authenticator device. The conditions include a combination of a list of authenticator devices, or a minimal number of the authenticator devices.

The authenticator device may be a mobile device with Bluetooth, NFC or WiFi capability. The RF frontend of the mass storage device may be configured to communicate through a Bluetooth, NFC, or WiFi connection.

In another aspect, the present patent application provides a wireless authentication, authorization and audit system. The system includes: a mass storage device; an authentication, authorization and audit server; a proxy device configured to establish a secure connection with the mass storage device; and at least an authenticator device configured to establish wireless communications with the proxy and the authentication, authorization and audit server. The mass storage device includes a processor connected with the computer, an RF frontend connected with the processor, and a memory storage connected with the processor. The processor is configured to encrypt data before the data is stored in the memory storage, to decrypt the data upon successful authentication, and to grant a user access to the data based on a passphrase, geographical location information, or proximity presence of the authenticator device.

The wireless authentication, authorization and audit system may include a plurality of authenticator devices. Upon a request from the proxy device, the authentication, authorization and audit server may be configured to send a notification to all the authenticator devices, and all the authenticator devices may be configured to communicate with the processor of the mass storage device via the proxy device.

The proxy device may be configured to send an authentication request to the authentication, authorization and audit server, and to receive a list of conditions to be fulfilled so as to authenticate the mass storage device, one of the conditions being related to at least one authenticator device.

In yet another aspect, the present patent application provides a method for wirelessly authenticating a user for accessing a mass storage device with at least an authenticator device. The method includes: encrypting data before storing the data in the mass storage device; decrypting the data upon successful authentication; establishing wireless communication between the authenticator device and the mass storage, and wireless communication between the authenticator device and an authentication, authorization and audit server; and granting the user access to the data based on a passphrase, geographical location information, or proximity presence of the authenticator device.

The wireless communication between the authenticator device and the mass storage device may be based on proximity, and the wireless communication between the authenticator device and the authentication, authorization and audit server may be based on the Internet. The wireless communication between the authenticator device and the mass storage device may be carried out through a proxy device.

### BRIEF DESCRIPTIONS OF THE DRAWINGS

FIG. 1 illustrates a wireless two-factor authentication, authorization and audit (AAA) system in accordance with an embodiment of the present patent application.

FIG. 2 is a block diagram of a portable mass storage device in the system.

FIG. 3 is a flow chart illustrating a local mode embodiment of the present patent application.

FIG. 4 illustrates a wireless two-factor authentication, authorization and audit (AAA) system in accordance with another embodiment of the present patent application.

FIG. 5 is a flow chart illustrating a remote mode embodiment of the present patent application.

FIG. 6 illustrates a wireless two-factor authentication, authorization and audit (AAA) system in accordance with yet another embodiment of the present patent application.

FIG. 7 is a flow chart illustrating a server-based mode embodiment of the present patent application.

FIG. 8 illustrates a wireless two-factor authentication, authorization and audit (AAA) system in accordance with still another embodiment of the present patent application.

FIG. 9 is a flow chart illustrating a multi-party mode embodiment of the present patent application.

FIG. 10 is a flow chart illustrating a multi-conditional mode embodiment of the present patent application.

### DETAILED DESCRIPTION

Reference will now be made in detail to a preferred embodiment of the wireless two-factor authentication, authorization and audit system disclosed in the present patent application, examples of which are also provided in the following description. Exemplary embodiments of the system disclosed in the present patent application are described in detail, although it will be apparent to those skilled in the relevant art that some features that are not particularly important to an understanding of the system may not be shown for the sake of clarity.

Furthermore, it should be understood that the system disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

In one embodiment, the local-mode authentication mechanism involves a portable mass storage hardware, which communicates wirelessly (e.g. Bluetooth, Near Field Communication (NFC)) to an authenticator device, which typically is a wireless communication device, such as an iPhone or an Android mobile phone or tablet, with WiFi, Bluetooth, NFC and/or Global Positioning System (GPS) capabilities. The authenticator device in turn communicates to cloud-based authentication, authorization and audit server via the Internet.

The authentication factors may include a combination of:
1. the end user has access to a pre-registered authenticator device;
2. a correct passphrase is entered on the authenticator device;
3. the authenticator device is in close proximity to the portable mass storage device; and
4. both the authenticator device and the portable mass storage device are all within permitted geographic locations.

In another embodiment, a remote-mode authentication mechanism requires a proxy device, which typically is another communication device (e.g. a second iPhone, Android phone or tablet) to proxy message communication between the portable mass storage hardware and the authenticator device. With this remote-mode authentication mechanism, multi-party and multi-condition authorizations can be enforced with close-proximity and permitted geographical locations.

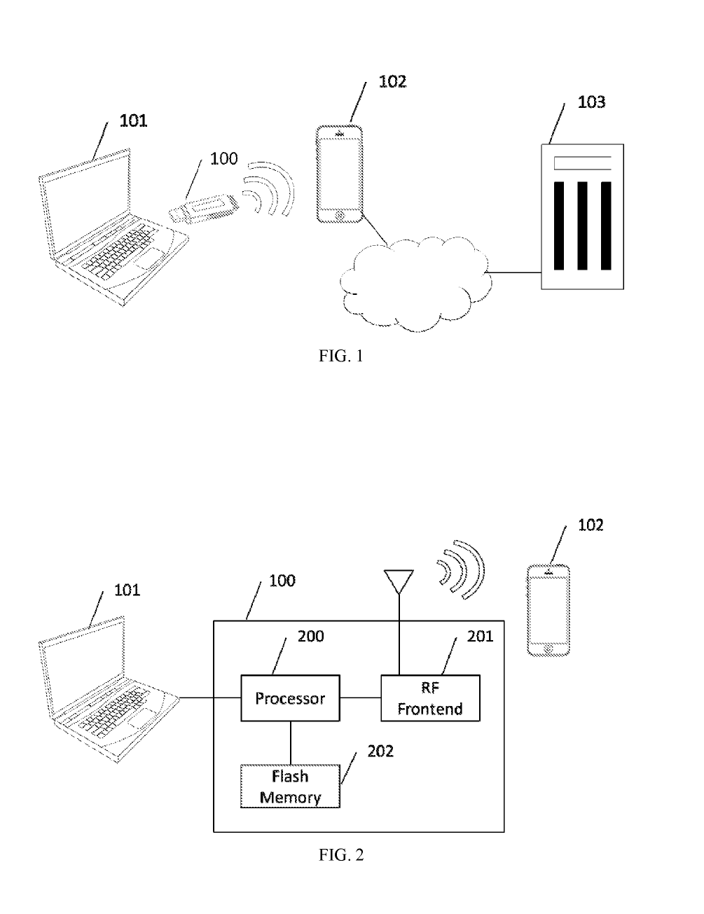

FIG. 1 illustrates a wireless two-factor authentication, authorization and audit (AAA) system in accordance with an embodiment of the present patent application. Referring to FIG. 1, the AAA system includes a portable mass storage device 100 to be accessed by a host computer 101. The portable mass storage device 100 communicates wirelessly (e.g. Bluetooth or NFC) to an authenticator device 102, which typically is an iPhone, an Android mobile phone or a tablet with Bluetooth (or NFC) capability. The authenticator device 102 in turn communicates to a cloud-based authentication, authorization and audit (AAA) server 103 via the Internet.

The portable mass storage device 100 is in a locked state when it is first plugged into the host computer 101. In the locked state, it remains invisible to the host computer 101. File contents on the portable mass storage device 100 can only be accessed when the portable mass storage gets authenticated successfully and switches to an unlocked state.

FIG. 2 is a block diagram of the portable mass storage device 100. Referring to FIG. 2, the portable mass storage device 100 includes a processor 200, a wireless (e.g. Bluetooth or NFC) Radio Frequency (RF) frontend 201 and a flash memory 202. The RF frontend 201 of the mass storage device 100 is configured to communicate through a Bluetooth, NFC or WiFi connection.

The processor 200 interfaces to the host computers 101 via a USB/Thunderbolt/E-SATA connection. This interface conforms to the corresponding mass storage device specification. File contents coming in from the host computer 101 are first encrypted by the processor 200 before being stored into the flash memory 202.

When being powered up, the portable mass storage device 100 is in the locked state, and the portable mass storage device 100 remains invisible to the host computer 101. Only after successful authentication with an authenticator device 102, the encrypted file contents on the flash memory 202 will be decrypted by the processor 200 and made available to the host computer 101.

The wireless (e.g. Bluetooth or NFC) RF frontend 201 interfaces to the processor 200 via communication bus (e.g. SPI, GPIO, i2c), providing wireless (e.g. Bluetooth or NFC) connectivity to the authenticator device 102, over which authentication messages are exchanged.

### Local Mode

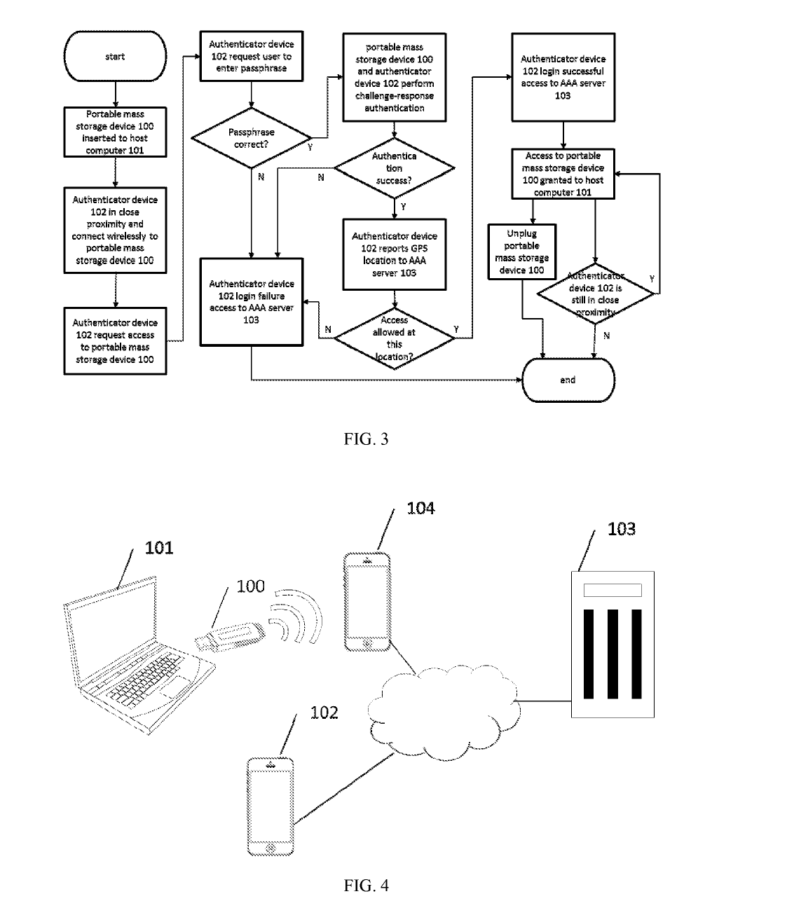

In the embodiment illustrated by FIG. 1, a local mode wireless two-factor authentication process takes place, which is further illustrated by the flow chart in FIG. 3. Referring to FIG. 3, the process includes:
1. A specific authenticator device 102 manages to connect wirelessly to the portable mass storage device 100. A successful connection is made upon successful wireless connection (e.g. Bluetooth or NFC) physical layer authentication;
2. A correct passphrase is entered by a user on the authenticator device and authenticated by the authenticator device;
3. A successful upper layer challenge-response authentication takes place between the portable mass storage device 100 and the authenticator device 102;
4. A GPS in the authenticator device 102 obtains a geographical location of the authenticator device 102, reports the location information to the authentication, authorization and audit server 103, and the authentication, authorization and audit server 103 checks against a access white list and approves the access at this geographical location.

The unlocked state of the portable mass storage device 100 is maintained only if the authenticator device 102 is in close proximity of the portable mass storage device 100 so that the wireless connection can be maintained. When the authenticator device 102 moves out of range and the wireless connection drops, the portable mass storage device 100 returns to the locked state, and the access to contents from the host computer 101 will be revoked. In other words, the processor 200 stops to grant access to the user when the authenticator device 102 is out of the proximity of the mass storage device 100. It is noted that wireless communications such as Bluetooth or NFC communications works within a certain proximity. In other words, the wireless communication between the authenticator device and the mass storage device is based on proximity.

### Remote Mode

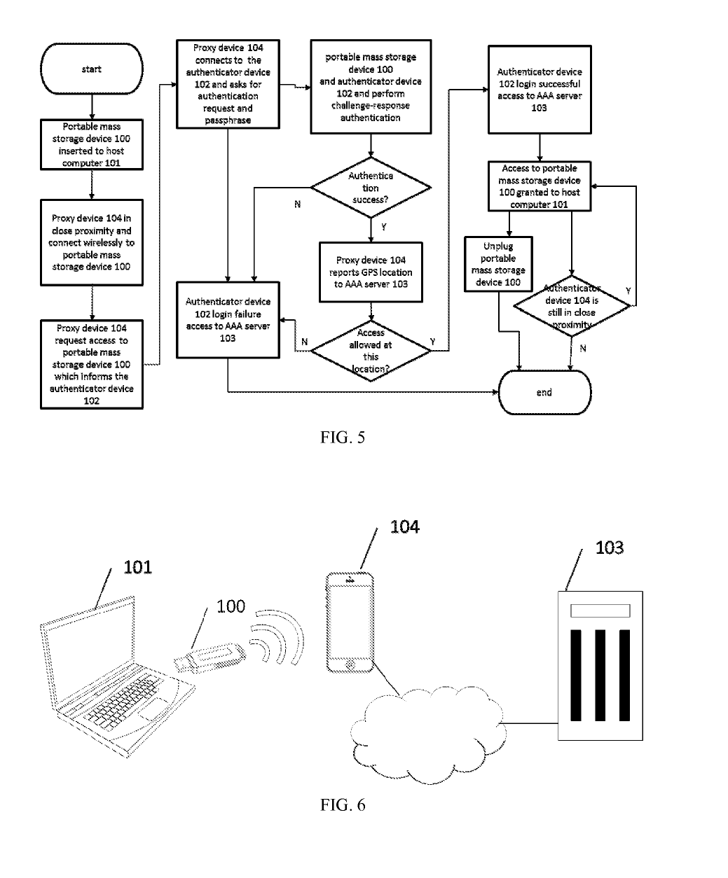

FIG. 4 illustrates a wireless two-factor authentication, authorization and audit (AAA) system in accordance with another embodiment of the present patent application. In this embodiment, a remote mode wireless two-factor authentication process, which is illustrated by the flow chart in FIG. 5, includes:
1. A proxy device 104 manages to connect wirelessly to portable mass storage device 100. A successful connection includes wireless connection (e.g. Bluetooth or NFC) to setup the physical layer authentication;
2. The proxy device 104 starts a remote-mode authentication request to the authentication, authorization and audit server 103;
3. The owner (or user) of the authenticator device 102 is notified by the authentication, authorization and audit server 103 and a secure communication channel will be established for the authenticator device 102 to communicate with the mass storage device 100 via the proxy device 104;
4. The owner of the authenticator device 102 can thus unlock the mass storage device 100 without disclosing the passphrase to others.

### Server-Based Mode

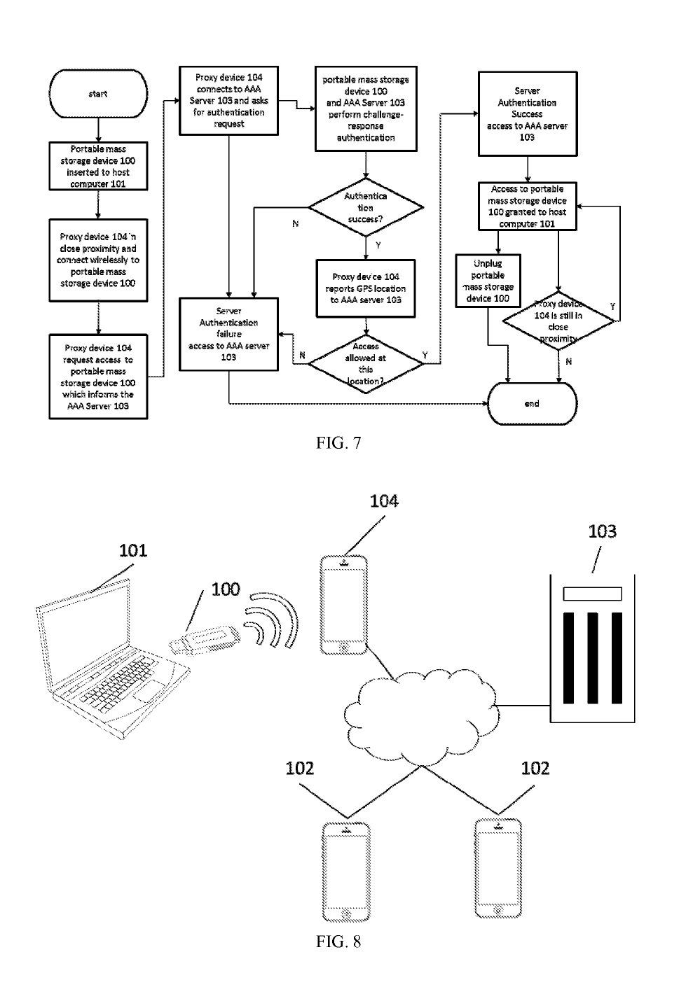

FIG. 6 illustrates a wireless two-factor authentication, authorization and audit (AAA) system in accordance with yet another embodiment of the present patent application. In this embodiment, a server-based mode wireless two-factor authentication process, which is illustrated by the flow chart in FIG. 7, includes:
1. The proxy device 104 manages to connect wirelessly to the portable mass storage device 100. A successful connection includes wireless connection (e.g. Bluetooth or NFC) to setup the physical layer authentication;
2. The proxy device 104 starts a server-mode authentication request to the authentication, authorization and audit server 103;
3. Upon successful authentication, the authentication, authorization and audit server 103 is configured to send an authenticated message back to the proxy device 104.

### Multi-Party Mode

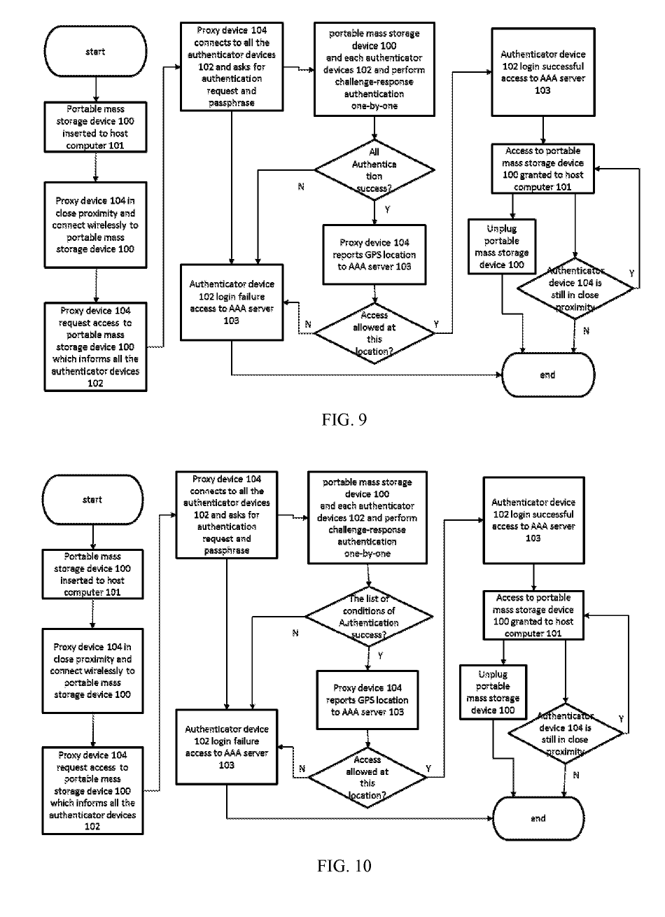

FIG. 8 illustrates a wireless two-factor authentication, authorization and audit (AAA) system in accordance with still another embodiment of the present patent application. In this embodiment, a multi-party mode wireless two-factor authentication process, which is illustrated by the flow chart in FIG. 9, includes:
1. The proxy device 104 manages to connect wirelessly to the portable mass storage device 100. A successful connection includes wireless connection (e.g. Bluetooth or NFC) to setup the physical layer authentication;
2. The proxy device 104 identifies that the portable mass storage device 100 requires multiple authenticator devices 102 and the proxy device 104 starts a remote-mode authentication request to the authentication, authorization and audit server 103, which in turn notifies all the owners of the authenticator devices 102;
3. All the owners of the authenticator devices 102 are notified by the authentication, authorization and audit server 103 and a secure communication channel will be established for the owner to communicate with the proxy device 104;
4. All the owners of the authenticator devices 102 need to provide the corresponding passphrase and/or be within the permitted geographical location. Until all the authenticator devices 102 have provided the correct passphrase, the portable mass storage device 100 can be unlocked successfully;
5. The proxy device 104 can be one of the authenticator devices 102.

### Multi-Conditional Mode

According to another embodiment of the present patent application, a multi-conditional mode wireless two-factor authentication process, which is illustrated by the flow chart in FIG. 10, includes:
1. The proxy device 104 manages to connect wirelessly to the portable mass storage device 100. A successful connection includes wireless connection (e.g. Bluetooth or NFC) to setup the physical layer authentication;
2. The proxy device 104 identifies that the portable mass storage device 100 requires a number of conditions to be satisfied. The proxy device 104 starts a remote-mode authentication request to the authentication, authorization and audit server 103 to get the list of conditions, one of which is related to at least one authenticator device 102, in order to unlock the portable mass storage device 100;
3. All the possible owners of the authenticator devices 102 are notified via the authentication, authorization and audit server 103 and a secure communication channel will be established for the owners to communicate with the mass storage device 100 via the proxy device 104.
4. The owners of the authenticator devices 102 provide the corresponding passphrases and/or need to be within the permitted geographical locations. Upon successful authentication, an authenticated message will be sent back to the proxy device 104.
5. Until the required conditions are satisfied, the proxy device 104 will unlock the portable mass storage device 100.
6. The proxy device 104 and the authentication, authorization and audit server 103 may be one of the authenticator devices 102.
7. The list of conditions may include any combination of a list of authenticator devices 102 or a minimal number of the listed authenticator devices 102.

While the present patent application has been shown and described with particular references to a number of embodiments thereof, it should be noted that various other changes or modifications may be made without departing from the scope of the present invention.

What is claimed is:

1. A wireless two-factor authentication, authorization and audit system comprising:
a mass storage device being connected with a computer;
a cloud-based authentication, authorization and audit server being connected with the Internet; and
an authenticator device configured to establish wireless communication with the mass storage device, and to communicate with the authentication, authorization and audit server via the Internet; wherein:
the mass storage device comprises a processor connected with the computer, an RF frontend connected with the processor, and a memory storage connected with the processor; and
the processor is configured to encrypt data before the data is stored in the memory storage, to decrypt the data upon successful authentication, and to grant a user access to the data based on a passphrase, geographical location information, or proximity presence of the authenticator device.

2. The wireless two-factor authentication, authorization and audit system of claim 1, wherein the authenticator device is configured to establish a wireless connection with the mass storage device upon successful wireless connection physical layer authentication between the authenticator device and the mass storage device.

3. The wireless two-factor authentication, authorization and audit system of claim 2, wherein the authenticator device is configured to authenticate a passphrase input by a user.

4. The wireless two-factor authentication, authorization and audit system of claim 3, wherein the portable mass storage device and the authenticator device are configured to perform an upper layer challenge-response authentication.

5. The wireless two-factor authentication, authorization and audit system of claim 4, wherein the authenticator device comprises a GPS, the GPS being configured to obtain the geographical location of the authenticator device, and report the geographical location to the authentication, authorization and audit server for authentication.

6. The wireless two-factor authentication, authorization and audit system of claim 1, wherein the processor stops granting access to the user when the authenticator device is out of the proximity of the mass storage device.

7. The wireless two-factor authentication, authorization and audit system of claim 1 further comprising a proxy device being in wireless communication with the mass storage device, wherein the proxy device is configured to send an authentication request to the authentication, authorization and audit server, and the authenticator device is configured to receive a notification from the authentication, authorization and audit server, and to communicate with the mass storage device through a secure communication channel via the proxy device.

8. The wireless two-factor authentication, authorization and audit system of claim 1 further comprising a proxy device being in wireless communication with the mass storage device, wherein the proxy device is configured to start a server-mode authentication request to the authentication, authorization and audit server, and upon successful authentication the authentication, authorization and audit server is configured to send an authenticated message back to the proxy device.

9. The wireless two-factor authentication, authorization and audit system of claim 7 comprising a plurality of authenticator devices, wherein upon a request from the proxy device, the authentication, authorization and audit server is configured to send a notification to all the authenticator devices, and all the authenticator devices are configured to communicate with the processor of the mass storage device via the proxy device.

10. The wireless two-factor authentication, authorization and audit system of claim 9, wherein the proxy device is one of the authenticator devices.

11. The wireless two-factor authentication, authorization and audit system of claim 7, wherein after sending an authentication request to the authentication, authorization and audit server, the proxy device is configured to receive a list of conditions to be fulfilled so as to authenticate the mass storage device, one of the conditions being related to at least one authenticator device.

12. The wireless two-factor authentication, authorization and audit system of claim 11, wherein the conditions comprise a combination of a list of authenticator devices, or a minimal number of the authenticator devices.

13. The wireless two-factor authentication, authorization and audit system of claim 1, wherein the authenticator device is a mobile device with Bluetooth, NFC or WiFi capability.

14. The wireless two-factor authentication, authorization and audit system of claim 13, wherein the RF frontend of the mass storage device is configured to communicate through a Bluetooth, NFC, or WiFi connection.

15. A wireless authentication, authorization and audit system comprising:
a mass storage device;
an authentication, authorization and audit server;
a proxy device configured to establish a secure connection with the mass storage device; and
at least an authenticator device configured to establish wireless communications with the proxy and the authentication, authorization and audit server; wherein:
the mass storage device comprises a processor connected with the computer, an RF frontend connected with the processor, and a memory storage connected with the processor; and
the processor is configured to encrypt data before the data is stored in the memory storage, to decrypt the data upon successful authentication, and to grant a user access to the data based on a passphrase, geographical location information, or proximity presence of the authenticator device.

16. The wireless authentication, authorization and audit system of claim 15 comprising a plurality of authenticator devices, wherein upon a request from the proxy device, the authentication, authorization and audit server is configured to send a notification to all the authenticator devices, and all the authenticator devices are configured to communicate with the processor of the mass storage device via the proxy device.

17. The wireless authentication, authorization and audit system of claim 15, wherein the proxy device is configured to send an authentication request to the authentication, authorization and audit server, and to receive a list of conditions to be fulfilled so as to authenticate the mass storage device, one of the conditions being related to at least one authenticator device.

18. A method for wirelessly authenticating a user for accessing a mass storage device with at least an authenticator device, the method comprising:
encrypting data before storing the data in the mass storage device;
decrypting the data upon successful authentication;
establishing wireless communication between the authenticator device and the mass storage, and wireless communication between the authenticator device and an authentication, authorization and audit server; and
granting the user access to the data based on a passphrase, geographical location information, or proximity presence of the authenticator device.

19. The method of claim 18, wherein the wireless communication between the authenticator device and the mass storage device is based on proximity, and the wireless communication between the authenticator device and the authentication, authorization and audit server is based on the Internet.

20. The method of claim 18, wherein the wireless communication between the authenticator device and the mass storage device is carried out through a proxy device.
